(19) United States
(12) Patent Application Publication
(10) Pub. No.: US 2020/0037577 A1
(43) Pub. Date: Feb. 6, 2020

(54) PET-FEEDER DEVICE

(71) Applicant: PETCUBE, INC., San Francisco, CA (US)

(72) Inventor: Michael Dzamba, San Francisco, CA (US)

(21) Appl. No.: 16/256,999

(22) Filed: Jan. 24, 2019

Related U.S. Application Data
(60) Provisional application No. 62/622,756, filed on Jan. 26, 2018.

(51) Int. Cl. A01K 5/00; A01K 7/02; A01K 5/02

(52) U.S. Cl. CPC A01K 5/001; A01K 5/0225; A01K 7/027

(57) ABSTRACT

A pet-feeder device is provided. The pet-feeder device may include a casing, a printed circuit board, at least one compartment, at least one mixer, and a tray. The mixer may be located below at least one compartment. The tray may include at least one bowl. The tray may be located below the mixer.

### CROSS-REFERENCE TO RELATED APPLICATIONS

The present application claims priority to U.S. Provisional Application No. 62/622,756 that was filed on Jan. 26, 2018, which is incorporated herein by reference in its entirety.

### TECHNICAL FIELD

This invention relates generally to pet-feeder devices and more particularly to pet-feeder devices that mix dried pet food with liquids to create nutritious pet food.

### BACKGROUND OF THE INVENTION

Millennials are putting off marriage and children but they're increasingly adopting pets. Sixty-five percent of U.S. households have at least one pet—up from fifty-six percent in 2012—which means the market is immense but also growing very fast. Globally, over $100 billion were spent on pets last year and the bulk of it—$67 billion—was spent in the U.S. alone. As of 2017, ninety-five percent of U.S. pet owners consider pets to be family members and refer to themselves as pet parents instead of pet owners. This is a significant increase from sixty-three percent just five years ago. With this changing attitude to perceive pets as children, pet parents need a way to keep an eye on their pets, be able to interact with them, and most importantly, feed them nutritious food while they are away, such as during long hours at work, business trips, or weekend trips.

Controlling the diet of pets is important to ensure their health and happiness. In order to have a healthy pet, it is necessary to monitor its diet carefully, both for quality and quantity. While it is a simple and routine matter to provide water and food for a pet when the pet owners are at home, servicing the nourishment needs of a pet are far from routine when the pet owners are not at home. Diets and amounts are based on the individual pet and the life it leads. Thus, the proper feeding of a pet entails more than just leaving out a bowl of pet food for the pet to eat whenever it is hungry. However, because of the busy and irregular schedules of many of today's pet owners, it is difficult to maintain a uniform feeding schedule.

Some pet owners take care of these problems by hiring pet sitters for $$20-25/hour, which can amount to $$6000-7000 annually, which is expensive. Additionally, these pet sitters do not overcome the problem of the pet owners themselves not getting to interact with their pets and develop relationships with them.

Some pet-food/treat-dispensing devices are available in the market. For example, since May 2015, a pet-food/treat-dispensing device named Petzi has been available in the market. Since October 2016, a pet-food/treat-dispensing device named Furbo has been available in the market. And since October 2016, a pet-food/treat-dispensing device named Homdox Automatic Pet Feeder has been available in the market. PetSafe, available since April 2015, dispenses dry and semi-moist foods. Petnet, available since January 2015, is a smart feeder connected to a mobile application for dry foods. Petcube, Inc. has filed patent applications on remote interaction devices, U.S. Patent Pub. Nos. 2017/0142933 and 2014/0233096, which are incorporated herein in their entirety by reference.

All of these non-Petcube, Inc. products have poorly designed mechanics and appearance. Further, these products disperse treats that are shot at a certain distance, thus requiring the food to be solid and dry. There are many such types of dried pet food available in the market. The most advanced and healthiest dried pet foods are the freeze-dried foods as they have a high nutritional value that is like the nutritional value of a raw meat diet that a pet would normally eat. However, the freeze-dried foods are impossible for the pets to eat without mixing it with water, which is something that the owner has to do. Dried food that is produced by heating and drying processes has a lower nutritional value than freeze-dried food and a much lower nutritional value than raw food. The “crunchy” foods are of a lower quality than the “non-crunchy” dried food.

It is therefore desirable to provide a novel and efficient pet-feeder device for mixing and dispensing pet food that allows pet owners to feed their pets with the most nutritious pet food while being away from home. Such a pet-feeder device will ensure that the pets eat the most nutritious food by mixing the freeze-dried pet food with liquids. The pet-feeder device, thus, ensures the pet owners' peace of mind, increases efficiency, is more convenient to use, and can be used remotely at any time, all the while providing the pet with nutritious pet food. Thus, the pet-feeder device ensures that the pet is healthier and reduces the frequency of visits to veterinarians. Such a device is also able to feed pets remotely and as often as needed throughout the day with high quality, small portions of pet food, which is one of the required pet diets when the pet has any stomach or other disorders.

### SUMMARY OF THE INVENTION

Provided herein are embodiments of a pet-feeder device for freeze-dried food that may include a casing, a printed circuit board, at least one compartment, at least one mixer, and a tray. The mixer may be located below at least one compartment. The tray may include at least one bowl. The tray may be located below the mixer. Embodiments of the pet-feeder device facilitate the feeding of a pet remotely multiple times during the day with high grade, quality freeze-dried food that has a high nutritional value, is extremely healthy, and has a quality that is closest to raw food.

Other features and advantages of the present invention will be or will become apparent to one with skill in the art upon examination of the following figures and detailed description, which illustrate, by way of examples, the principles of the present invention.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, reference numerals designate corresponding parts throughout the different views.

FIGS. 1A and 1B illustrate perspective views of a pet-feeder device, according to exemplary embodiments of the present invention.

FIG. 2 illustrates a perspective view of a pet-feeder device, according to exemplary embodiments of the present invention.

FIG. 3 illustrates a perspective view of a pet-feeder device, according to exemplary embodiments of the present invention.

FIGS. 4A and 4B illustrate perspective views of a pet-feeder device, according to exemplary embodiments of the present invention.

FIG. 5 illustrates a perspective view of a mixer component of a pet-feeder device, according to exemplary embodiments of the present invention.

FIGS. 6A-6C illustrate perspective views of various pet food agitation methods employed by a mixer component of a pet-feeder device, according to exemplary embodiments of the present invention.

FIG. 7 illustrates a perspective view of a pet-feeder device mixing dried pet food and water, according to exemplary embodiments of the present invention.

FIG. 8 illustrates a perspective view of a pet eating pet food from a pet-feeder device, according to exemplary embodiments of the present invention.

FIG. 9 illustrates a front view of a remote device communicatively linked to a pet-feeder device, according to exemplary embodiments of the present invention.

### DETAILED DESCRIPTION

The below described figures illustrate embodiments of the described invention and method of use in at least one of its preferred, best mode embodiments, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

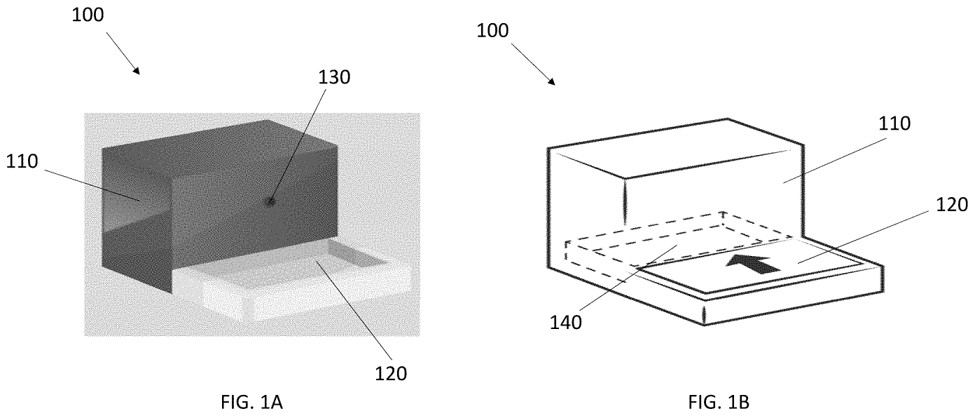

Turning to the figures, FIG. 1A illustrates a pet-feeder device 100, such as Petcube Licks. The pet-feeder device 100 may be electronic or non-electronic. The pet-feeder device 100 may include a casing 110. The casing may also include a camera 130. The camera 130 may be communicatively linked to a remote device, such as a smart phone, a tablet, a computer, or any other computing device that allows the pet owner to see the pet, monitor the surroundings of the pet-feeder device. The camera 130 may be communicatively linked to the remote device using any method, such as the internet, Bluetooth, electrical cords, etc. The remote device may be able to control when to switch on or switch off the camera 130, when to click photos, when to record videos, etc. The camera 130 may also be operated manually. There may be one or more cameras 130 on the casing 110. The camera 130 may also be located anywhere else on the pet-feeder device 100. The camera 130 may also be located separate from the pet-feeder device 100. The camera 130 may also be communicatively linked to other sensors, such as motion, pressure, light, accelerometers, and/or sound sensors present in the pet-feeder device 100. The camera 130 may also be communicatively linked to a speaker and/or a microphone. The camera 130 may also include a night vision module. Additional details about the camera may be found in U.S. Pat. No. 9,826,715 titled “Remote Interaction Device,” which is incorporated by reference herein in its entirety. The pet-feeder device 100 may also include a slidable tray 120. The tray 120 may be detachable. The pet-feeder device 100 may also include a cleaning system that facilitates cleaning of various parts of the pet-feeder device 100 such as the tray. The cleaning system may be internal or external. The cleaning system may be capable of being connected to a faucet or other water dispensing evidence to flush water into the pet-feeder device 100.

As illustrated in FIG. 1B, the slidable tray 120 may slide into space 140 in the casing 110 of the pet-feeder device 100 when the dried pet food is being mixed with liquid to create a nutritious pet food. The tray 120 may slide completely in such that it is inaccessible to the pet or only partially into the space 140. The tray 120 may slide out of the space 140 when the nutritious pet food is prepared. The tray 120 may be operated manually or may function automatically. The tray 120 may be communicatively linked to a remote device using any method, such as the internet, Bluetooth, etc. The remote device may be able to control when the tray 120 may be slid into the space 140 and/or when it comes out. The tray 120 may be of any dimension.

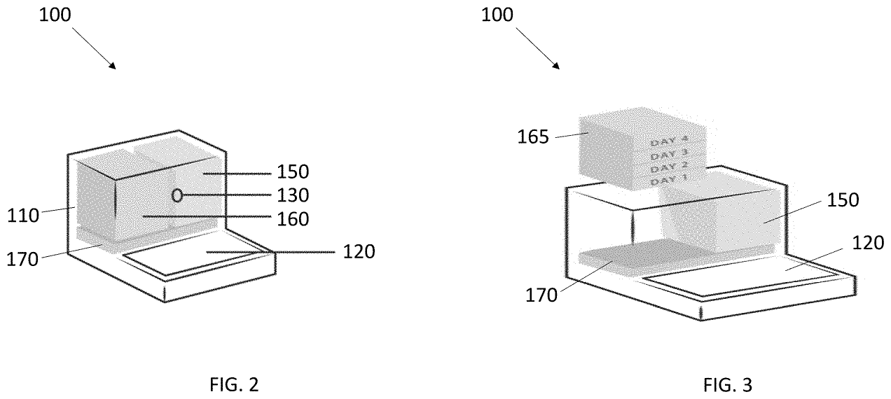

FIG. 2 illustrates a pet-feeder device 100 with a slidable tray 120, casing 110, a mixer 170, and at least two compartments 150 and 160. One compartment 160 (“food compartment”) may store dried pet food, such as the freeze-dried food, and the other compartment 150 (“liquid compartment”) may store liquid that may be used to mix with the dried pet food. The food compartment 160 may be able to hold any amount of pet food, 1 lb., 5 lbs., 10 lbs., etc. The compartments 150, 160 may have any dimensions according to the needs of the user, such as 10×10×6 inches. In some embodiments, the food compartment 160 may have a different dimension than the liquid compartment 160. For example, the liquid compartment 150 may have a volume that is 3 times that of the food compartment 160. Various parts of the pet-feeder device 100 may be made of any material such as plastic, metal, etc. The tray 120 may be made of any food-grade material that does not react in an adverse manner with the pet food or the liquid and is safe for the pets. The tray 120 may also be made of stainless steel. The tray 120 may also have self-cleaning features, such as antibacterial coatings. The food compartment 160, water compartment 150, mixer 170, and/or the tray 120 may be detachable from the pet-feeder device 100, so that they can be cleaned separate from the pet-feeder device 100. The food compartment 160 and/or the water compartment 150 may be communicatively linked to a remote device, which may be able to control its function remotely.

As illustrated in FIG. 3, the food compartment may either be its own separate compartment or merely an empty space in the casing 110. The pet-food cartridges 165 may be loaded into the food compartment. The pet-food cartridges 165 may stacked on top of each other horizontally or next to each other vertically. The pet-food cartridges 165 may be capable of switching their order of use. For example, if a user wishes to use “day 2” cartridges instead of “day 1” cartridges, the user may be able to manually or automatically switch the order of the cartridges using a remote device, such as a smartphone and a mobile application, designed to work with the device. In some embodiments, the pet-food cartridges 165 may be brought from outside vendors or suppliers. In other embodiments, there may be no food cartridges and the user may be able to simply add the pet food into the food compartment.

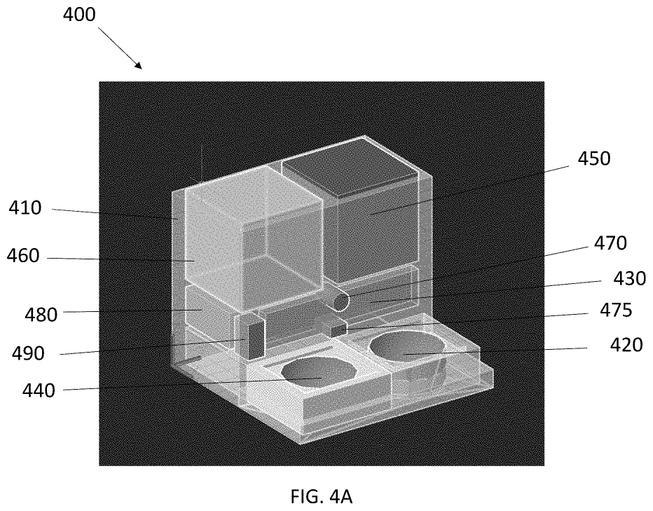

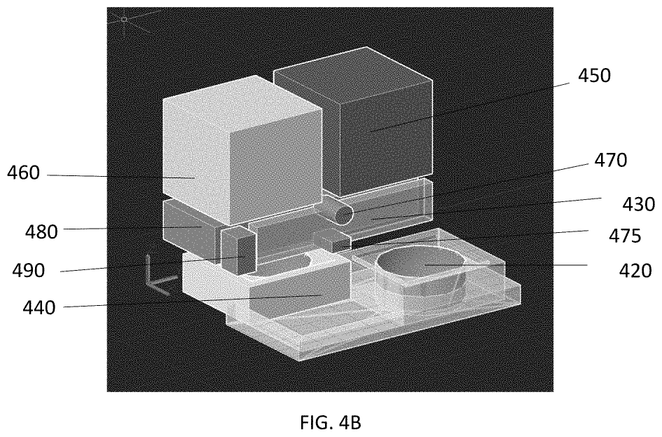

FIG. 4 illustrates a pet-feeder device 400. As illustrated, the pet-feeder device 400 may include a casing 410, a food compartment 460, a water compartment 450, a main printed circuit board (“PCB”) 430, a wide-angle camera module 470, for example 180 degrees with digital tilt and zoom with or without a night vision module, one or a set of microphones 475 to carry voice commands services, such as Amazon Alexa, at least one speaker 490, a water bowl 420, a food bowl 440, and/or a mixer 480. The PCB 430 may include an ARM processor, a RAM Storage, motor controllers, and/or sensors. The PCB 430 may also be Wi-Fi, Bluetooth, etc. compatible. The PCB 430 may be the part that allows the pet-feeder device 400 to be communicatively linked to a remote device, such as a smartphone, tablet, etc. The parts described herein may function as described in other figures. The primary purpose of the food compartment 460 is to hold freeze-dried food in its dehydrated state and slowly channel this food into the mixing component when requested by the system controller. The system controller may be managed by the user using the remote device and physically being present in the same or remote location. The container may function in either of the following two modes. In some embodiments, the food compartment 460 may store a single freeze-dried food powder. In other embodiments, the food compartment 460 may be loaded with pet-food cartridges designed to provide one meal per cartridge to the pet. In some embodiments, the pet-food cartridges can be stacked on top or next to each other as described above. The order of the pet-food cartridges' use may be predetermined at cartridge creation and then processed in chronological order by the pet-feeder device 400 on demand. The pet-food cartridges can have any shape, such as pyramidal, cubical, semi spherical, spherical, etc. The pet-food cartridges may have some identification indicia that can be read by the pet-feeder device 400 that may allow it to analyze what pet food to dispense, the amount to dispense, and the amount of water that is required by the selected pet food. After use, the empty pet-food cartridge may be compacted and stored on the side of the mixer 480. The primary purpose of the water compartment 450 is to hold fresh water and to keep it fresh. The water compartment 450 or a system attached to the water compartment 450 may include a water freshening system that may freshen the water by: 1) circulating water continuously so as to not leave the water standing. This may be done by using a small electrical pump to circulate the water from the bottom to the top of the water compartment 450 internally or pump the water through a circulation loop including the water bowl 420; 2) using a UV LED or light tube that can be added to at least a part of the water compartment 450 to sterilize water as it stands still in the water compartment 450 or as it circulates, as described above; or 3) using a charcoal filter to filter the water as it circulates through the water compartment 450. Any of these methods may be used in isolation or in combination with each other. The main PCB 430 may include a fully-embedded Linux device (CPU, RAM, Storage, etc.). It may also include peripheral connectors to control the camera 470, microphone 475, speaker 490, the mixer 480, power management (AC to DC), and/or movement of the food bowl 440 from the retracted position to the exposed position and vice versa. The mixer 480 may include further components, such as motors, electrical pumps, sensors (such as infrared sensors that would scan the surface and the depth of the mixer), instant water heater, etc. The primary purpose of the camera 470 is to monitor the food, water, and the pet through image analysis. The camera 470 may be communicatively linked to a remote device. The camera 470 may be hidden within the casing 410 or it may protrude out of the casing 410. In some embodiments, it may be angled such that the food bowl 440 and the water bowl 420 are fully visible in its field of view along with the pet when it is eating from the food bowl 440 or the drinking from the water bow 420. One function of the camera 470 may be to identify which pet is currently eating (when multiple pets are present in the home). Another function of the camera 470 may be to estimate how much food has been eaten by each pet in the house. This may be done by visually estimating how many food pixels have been eaten and then assigning this estimate to the pet recognized in the field of view. Any other manner of estimating how much food has been eaten may also be used such as by using weight or pressure sensors. The primary use of the microphone 475 may be to infer whether the pet is currently eating food or water. In addition to this, the microphone 475 may be used to record audio to attach to any recorded video clips from the camera. The primary use of the speaker 490 may be to indicate to the pet when the pet food is ready. The speaker 490 may also be used to deter a pet from eating pet food by playing annoying sounds in either the regular human audio range or the ultrasonic range. Also, the speaker may be used for the pet owner to communicate with a pet using a communicatively-linked device such as a smartphone in a remote location. There may also be an LED element to the pet-feeder device 400. The main purpose of the LED element may be to communicate any status to the owner, such as when the pet is nearby, when the pet is eating, when the pet has finished eating, etc. The LED element may also be used in a bright mode to deter a pet from eating pet food by annoying them. The primary use of the water bowl 420 may be to dispense water directly to a pet. To prevent any stagnant water, the water compartment 450 may be equipped with a pump (not pictured) to continuously circulate the water and keep it moving through the water bowl 420. Thus, the water bowl 420 may be a part of the circulation loop through the water compartment 450 so that fresh water is continuously circulating in the water bowl 420. Any other method of providing fresh water to the water bowl may be used as well. The primary use of the food bowl 440 may be to prepare pet food and then to serve it to the pet. The food bowl 440 can be rescinded into the device, as described above, so that it is not accessible to the pet when rescinded. During the rescinded phase, as illustrated in FIG. 4B, pet food is prepared in the bowl. When the pet food is prepared, the food bowl 440 ejects out with the pet food and is exposed to the pet so that it can eat the pet food.

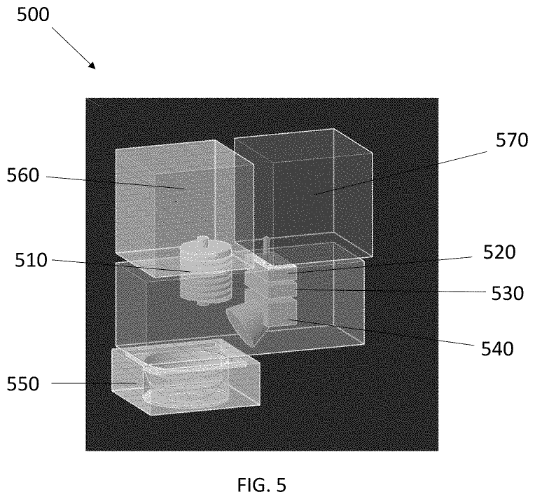

FIG. 5 illustrates one of the ways in which the mixer component 500 of a pet-feeder device works. The primary purpose of the mixer component 500 is to mix freeze-dried food with water in such a way to properly prepare the nutritious pet food. This process involves moving food from the food compartment 560 to the food bowl 550 and adding in water from the water compartment 570. Additionally, the mixer component 500 may heat the water as it passes into the food bowl 560 and also may be used to agitate (mix) the food and water mixture. In some embodiments, the agitation may be accomplished through a worm gear 510 that may be used to spin in place and slowly take food from the food compartment 560 and pass it into the empty food bowl 555 below. Next, a water pump 520 may be used to pump pressured water down from the food compartment 560 and/or the water compartment 570 towards the food bowl 550. Optionally, a water heater 530 may be used to instantly heat up the water before entering the food bowl 550. Next, an electric misting device 540 (for example but not limited to a 1-3 MHz transducer) may be used to atomize pressurized water and aim the fine mist towards the food bowl 550. Finally, the mist may be mixed with the food as it comes out of the food compartment 560 in the food bowl 550.

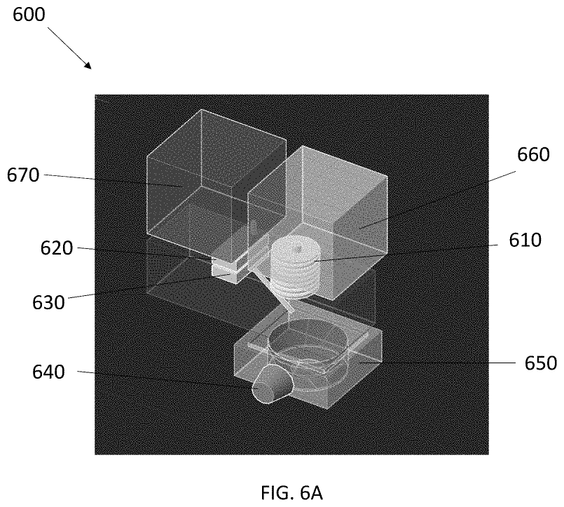

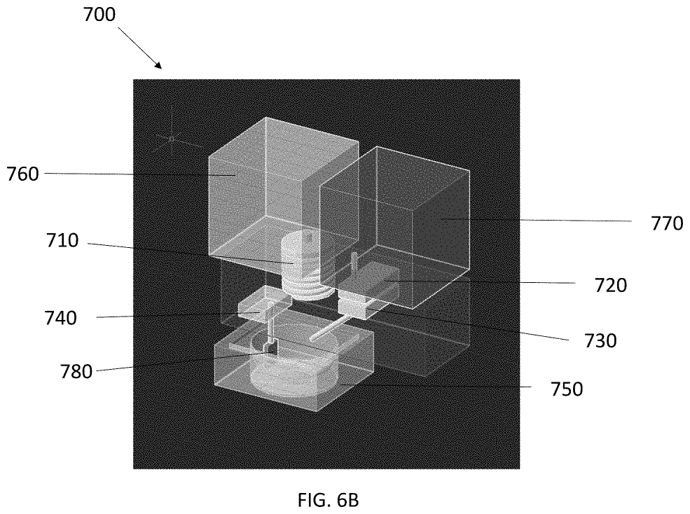

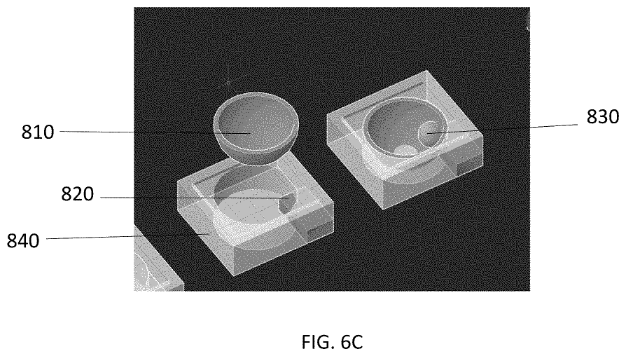

FIG. 6A illustrates one of the ways in which the mixer component 600 of a pet-feeder device agitates the pet food. Specifically, FIG. 6A illustrates the vibration transducer method of agitation. Per the vibration transducer method, a worm gear 610 is used to spin in place and slowly take food from the food compartment and pass it into the empty food bowl 650 below. Next, a water pump 620 may be used to pump pressured water down from the food compartment 660 towards the food bowl 650. Optionally, a water heater 630 may be used to instantly heat up the water from the water compartment 670 before entering the food bowl 650. Next, a vibration transducer 640 may be used to vibrate the bowl 650 and its contents at specific frequencies ranging between 60 Hz-1 MHz.

FIG. 6B illustrates one of the ways in which the mixer component 700 of a pet-feeder device agitates the pet food. Specifically, FIG. 6B illustrates the stirring method of agitation. Per the stirring agitation method, a worm gear 710 is used to spin in place and slowly take food from the food compartment 760 and pass it into the empty food bowl 750 below. Next, a water pump 720 may be used to pump pressured water down from the food compartment 760 and/or the water compartment 770 towards the food bowl 750. Optionally, a water heater 730 may be used to instantly heat up the water before entering the food bowl 750. Next, a motor 740 attached to stirring stick 780 may be used to mix the food and water mixture in the food bowl 750.

FIG. 6C illustrates one of the ways in which the mixer component of a pet-feeder device agitates the pet food. Specifically, FIG. 6C illustrates the bowl deformation method of agitation. Per the bowl deformation agitation method, a silicone or rubber food bowl 810 may be used and inserted into a proper position. Next, a solid obstacle 820 may be used to deform the bowl 810. Next, the bowl 810 may be spun around in place causing the bowl deformation 830 to travel around the bowl (relatively) and mix the contents in the bowl.

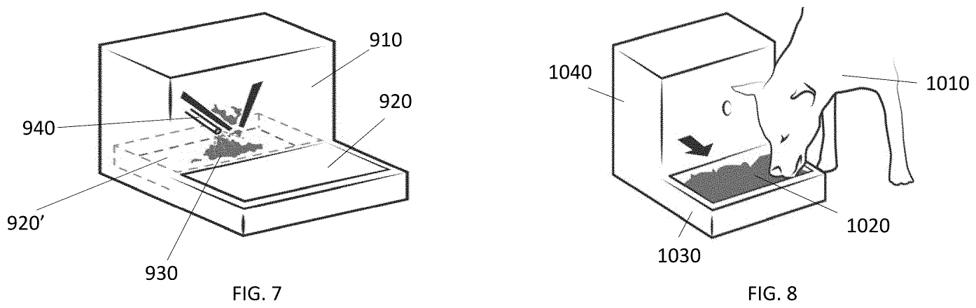

The main preprogrammed feature of the pet-feeder device is to prepare meals for your pet. The preparation process can differ based on which freeze-dried food is in the pet-feeder device. For this reason, each food cartridge in the food compartment or the food compartment itself may be marked with a special code allowing the device to identify the food type and adjust the preparation protocol accordingly. Alternatively, the user may “teach” the device which freeze-dried food and/or cartridges are to be used. To prepare a nutritious pet food, the pet-feeder device needs to receive a signal generated from one of the three sources: 1) Pre-programmed food schedule: This occurs when a signal is generated internally when a specific time has elapsed; 2) An application-initiated feeding: This occurs when a user uses an application installed in a remote device to initiate feeding the pets; and/or 3) When a user manually presses the feed button on the pet-feeder device itself. Once the pet feeding signal has been received, the pet-feeder device may slowly rescind the food bowl inwards so that it is no longer accessible to the pet. As illustrated in FIG. 7, once the food bowl 920 is rescinded (920′), the special pet-food code may be scanned, and the following protocol can be adjusted. However, in general, the pet food 930 is slowly moved from the food compartment to the bowl by a worm gear. As the pet food 930 is moved, water may be injected into the mixture using the misting device 940. Once the pet food and correct water ratio, which may be determined based on the pet food, has been injected into the food bowl 920 additional agitation (Mechanical, Vibration, and/or or Bowl Deformation) may take place depending on the pet food. The correct pet-food-to-water ratio may be preprogrammed into the pet-feeder device 910 and/or the remote device. Once the pet food 930 is properly mixed in the food bowl 920, the nutritious pet food is left to sit a parameterized amount of time. The time may depend on the pet food 930. Once the nutritious pet food 1020 is ready, the food bowl 1020 is pushed out of the pet-feeder device 1010 making it available for the pet, as illustrated in FIG. 8. FIG. 8 illustrates a pet 1010 eating the nutritious pet food 1020 from the exposed tray 1030 of a pet-feeder device 1040.

In some embodiments, a sound may be played to notify the pet that the nutritious pet food is ready. In some embodiments, in addition to food preparation, the pet-feeder device may be preprogrammed with algorithms to estimate how much pet food has been eaten by each pet. If one pet is eating too much of the other pet's food, annoying sounds and/or flashing LEDs can be used to deter the pet from eating further. Finally, an optional cleaning step may be present in the pet-feeder device. This may be used to wash leftover food out of the food bowl into a small grey-water (dirty water) tank. The grey-water tank may be located inside or outside the pet-feeder device. To do this, the pet-feeder device may rescind the food bowl and inject water into it while agitating the bowl. The water may then be passed through the food bowl and into the grey-water tank. The grey-water tank may be user accessible and easily cleanable.

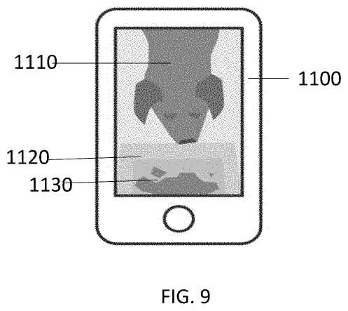

As described above and as illustrated in FIG. 9, the remote device 1100 may be installed with an application that is communicatively linked to the pet-feeder device. The primary purpose of the application is to report pet food eating statistics back to the owner. Specifically, the application may alert the owner when a meal has been dispensed. It may also alert the user when the pet has finished eating the pet food. It may also notify a user how quickly and how much nutritious pet food was eaten. The notification may comprise of a video or photo feed, as illustrated in FIG. 9. The photo or video may show the pet 1110, the tray 1120, and/or the nutritious pet food 1130. Another feature of the application may be to notify the user when it is time to feed the pet and to encourage the user to feed their pets directly, by physically pushing the feed button on the pet-feeder device. If the user is unable to feed the pet by manually pressing the feed button, then the application may present them with the option to feed the pet remotely through the remote device. Another feature of the application may be to use collected statistics and pet properties to predict what pet food the pet may like and what nutrients they most require. Once this information is available, the application may let you select and order pet foods depending on the pet's needs through third party sources. Some other notifications that may be sent by the application include: low pet food; pet is waiting for its pet food (may be detected by the camera recording the pet's pacing); pet is not eating well; pet is being bullied by another pet; pet ate its food at a certain speed; pet enjoyed the flavor of the pet food (based on how fast the pet food was eaten); pet X is eagerly waiting to be fed; etc. The pet-feeder device may be completely capable of being operated manually, i.e., without any assistance from the remote device. Further, the pet-feeder device may be capable of being preprogrammed, as described above. For example, if the owner sets the pet-feeder device to feed the pet food each day at a certain time, this will occur automatically.

In some embodiments, multiple devices, such an as iPad, mobile phone, laptop, desktop, etc., may be connected to each other through the application and the application may allow all the devices to be connected to the pet-feeder device. These remote devices may be connected to the application and may allow the user to switch back and forth between them. In some embodiments, the application may only require one login information across all the devices. In other embodiments, the login information for the application may be different for different devices. With the application, all the devices may have access to the camera, microphone, and/or the memory located in the pet-feeder device or outside the pet-feeder device. In some embodiments, if the users have several devices across one house or multiple houses, they may be able to link them all together using the application and access them all together or separately at any given time.

What is claimed is:

1. A pet-feeder device comprising:
a casing;
a printed circuit board;
at least one compartment;
at least one mixer,
wherein the mixer is located below at least one compartment;
a tray,
wherein the tray further comprises at least one bowl, and
wherein the tray is located below the mixer.

2. The pet-feeder device of claim 1, wherein the casing further comprising a camera.

3. The pet-feeder device of claim 2, wherein the camera is communicatively linked to a remote device.

4. The pet-feeder device of claim 2, wherein the camera is communicatively linked to at least one sensor.

5. The pet-feeder device of claim 2, wherein the camera is communicatively linked to a speaker.

6. The pet-feeder device of claim 2, wherein the camera is communicatively linked to a microphone.

7. The pet-feeder device of claim 1, wherein the tray is slidable.

8. The pet-feeder device of claim 1, wherein the tray is made of food-grade material.

9. The pet-feeder device of claim 1, wherein the tray is communicatively linked to a remote device.

10. The pet-feeder device of claim 1 further comprising a cleaning system.

11. The pet-feeder device of claim 1, wherein at least one compartment comprises a water freshening mechanism.

12. The pet-feeder device of claim 1, wherein the mixer comprises a water heater.

13. The pet-feeder device of claim 1, wherein the tray comprises self-cleaning features.

14. A method of dispensing nutritious pet food from a pet-feeder device comprising:
loading dried pet food into one compartment of the pet-feeder device;
filling another compartment of the pet-feeder device with water;
channeling the dried pet food and water into a mixer of the pet-feeder device,
mixing the dried pet food and water in the mixer to create a mixture of nutritious pet food; and
transferring the mixture of nutritious pet food into a tray of the pet-feeder device.

15. The method of dispensing nutritious pet food from a pet-feeder device of claim 14 further comprising freshening the water in the pet-feeder device by circulating the water in the pet-feeder continuously.

16. The method of dispensing nutritious pet food from a pet-feeder device of claim 14 further comprising freshening the water in the pet-feeder device by using a light source or charcoal filter.

17. The method of dispensing nutritious pet food from a pet-feeder device of claim 14, wherein mixing the pet food further comprises using a stirring method of agitation.

18. The method of dispensing nutritious pet food from a pet-feeder device of claim 14, wherein mixing the pet food further comprises using a vibration transducer method of agitation.

19. The method of dispensing nutritious pet food from a pet-feeder device of claim 14, wherein mixing the pet food further comprises using a bowl deformation method of agitation.

20. The method of dispensing nutritious pet food from a pet-feeder device of claim 14 further comprising communicatively linking the pet-feeder device to a remote device.
